(19) United States
(12) Patent Application Publication
(10) Pub. No.: US 2005/0099366 A1
(43) Pub. Date: May 12, 2005

(54) Method of displaying a sequence of video images on a plasma display panel

(76) Inventors: Herbert Hoelzemann, Merkelbach (DE); Jonathan Kervec, Paimpont (FR); Didier Doyen, La Bouxiere (FR)

Correspondence Address: Joseph S Tripoli;Thomson Licensing Inc, Patent Operations, PO Box 5312, Princeton, NJ, 08543-5312, US

(21) Appl. No.: 10/478,176

(22) PCT Filed: Apr. 30, 2002
(86) PCT No.: PCT/EP02/04746

(30) Foreign Application Priority Data
May 17, 2001 (FR) 01/06777

(51) Int. Cl. G09G 3/28

(52) U.S. Cl. 345/72

(57) ABSTRACT

The invention relates to a method of displaying a sequence of video images on a plasma display panel comprising a plurality of elementary cells coloured by phosphors (blue, green, red). According to the invention, a movement vector corresponding to movement between two successive images is computed and then the subscans associated with at least one type of phosphor is displaced, the amplitude of the displacement depending on the amplitude of the movement vector and on the type of phosphor. This allows the effects of image afterglow to be corrected.

The present invention relates to a method of displaying a sequence of video images on a plasma display panel.

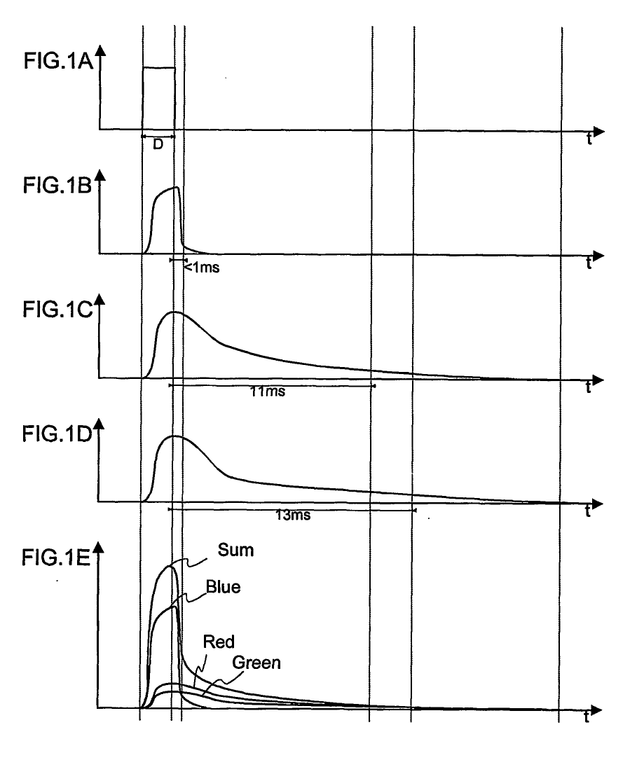

Plasma display panels (PDP) have, on their front wall, a layer of luminescent material which converts UV radiation into visible light. This luminescent material is commonly called a phosphor. Three types of phosphor are generally used to obtain a colour image, namely a blue phosphor, a red phosphor and a green phosphor. These three types of phosphor have different UV excitation time response characteristics. This disparity in the time response characteristics of the three types of phosphor is illustrated in FIGS. 1A to 1E. These figures show timing diagrams for the response of the phosphors customarily used in PDPs. FIG. 1A shows a period D during which UV radiation is produced. This UV radiation is then converted into visible light by the phosphors. FIG. 1B shows the light emitted by a blue phosphor, for example a barium magnesium aluminate doped with divalent europium. FIG. 1C shows the light emitted by a red phosphor, for example an yttrium borate doped with trivalent europium. FIG. 1D shows the light emitted by a green phosphor, for example a barium aluminate doped with manganese. FIGS. 1B to 1D are on different vertical scales in order to make the maximum values of these curves correspond. In fact, the maximum value of the blue is about 4.3 times greater than the maximum value of the red and about 5.5 times greater than that of the green. These timing diagrams allow the distribution of the light energy to be displayed for each colour. If the persistence times of the light energy of the various colours are compared, it may be seen that the persistence time of both red and green light is much longer than that of blue light. As an indicator, the figures show the durations after which the emitted light becomes less than 10% of the maximum value. These durations are measured starting from the end of the excitation in FIG. 1A. They are about 1 ms for blue light, 11 ms for red light and 13 ms for green light.

FIG. 1E shows the light renditions of the three colours with the same light scale and the sum of the three light renditions corresponds to what the human eye perceives for a pixel. Examination of the colour resulting from the sum of the three colours shows that the pixel is firstly blue, then passes from blue to white (or grey, depending on the light intensity of the colours) and then from white to yellow (the combination of red and green) before being extinguished.

In the case of a stationary image, this effect is filtered by the eye in such a way that it perceives only white. In contrast, in the case of a moving image, the eye is more sensitive to the variation in colour at the transitions, which are displaced. Thus, a white square moving on a black background is therefore tainted with a blue leading edge and a yellow trailing edge.

To remedy this afterglow problem, the only solutions known hitherto are to devise novel blue, red and green phosphors which have similar time responses.

It is an object of the invention to correct the display fault due to phosphor afterglow by video image processing.

Therefore, the invention relates to a method of displaying a sequence of video images on a plasma display panel comprising a plurality of elementary cells each including one type of phosphor from among at least two types of homogeneously distributed phosphors, the display of a video image taking place for a display period divided by a plurality of subscans during which each elementary cell emits or does not emit coloured light according to the type of phosphor with which it is associated. According to the method, a movement vector corresponding to movement between two successive images is computed and then the subscans associated with at least one type of phosphor are displaced, the amplitude of the displacement depending on the amplitude of the movement vector and on the type of phosphor.

The purpose of this subscan displacement is to delay the information delivered to at least one type of phosphor, especially a blue phosphor, and thus correct the afterglow effect.

The invention also relates to a plasma display panel comprising a plurality of elementary cells each including one type of phosphor from among at least two types of homogeneously distributed phosphors, the display of a video image taking place during a display period divided by a plurality of subscans during which each elementary cell emits or does not emit coloured light according to the type of phosphor with which it is associated. This panel includes a movement estimator for computing a movement vector corresponding to movement between two successive images and means for displacing the subscans associated with at least one type of phosphor, the amplitude of the displacement depending on the amplitude of the movement vector and on the type of phosphor.

Further features and advantages of the invention will become apparent on reading the detailed description which follows and which is given with reference with the appended drawings, in which:

FIGS. 1A to 1E represent timing diagrams for the time response of phosphors;

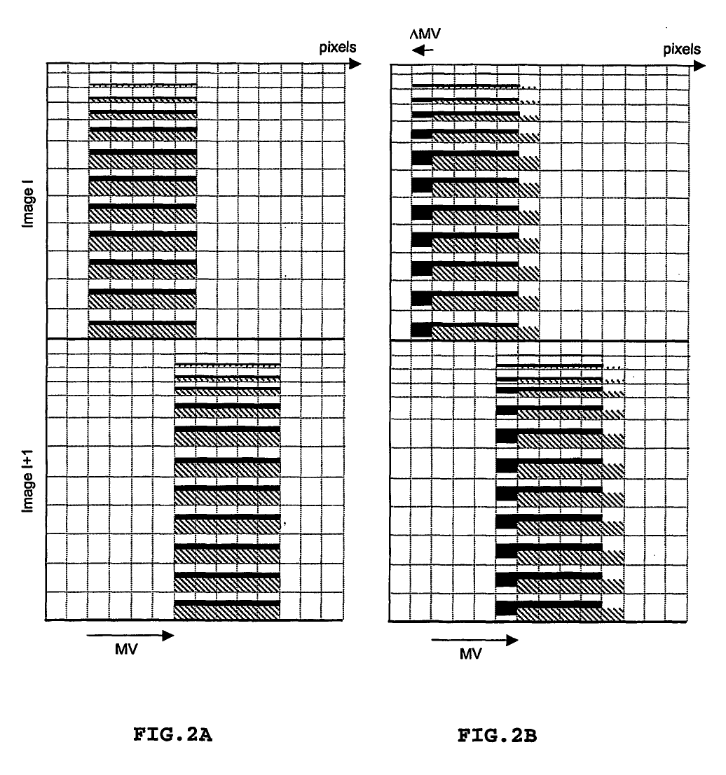

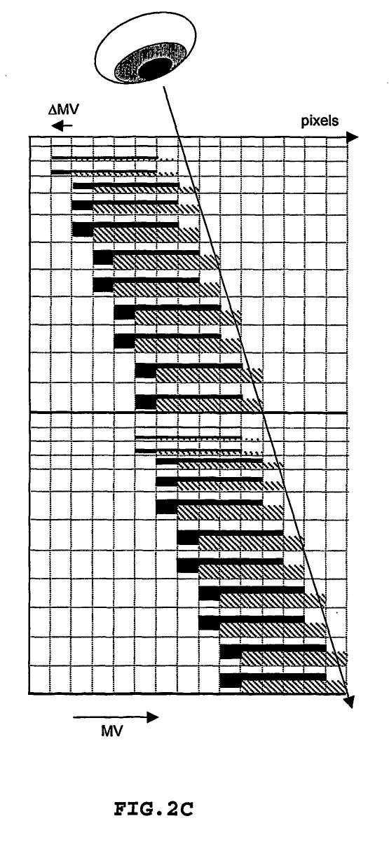

FIG. 2A shows the subscans for a moving object in two successive images;

FIG. 2B illustrates a first way of implementing the invention;

FIG. 2C illustrates a second way of implementing the invention; and

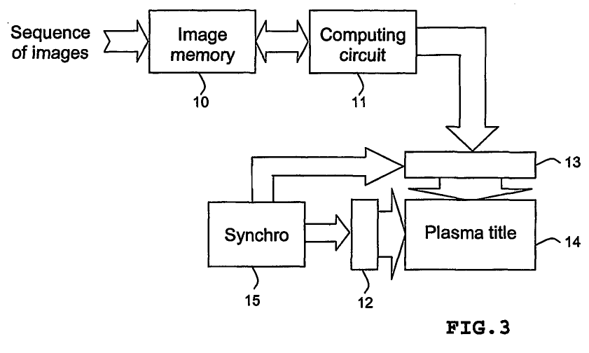

FIG. 3 shows an example of a system allowing the method of the invention to be implemented.

As mentioned above, the blue phosphor has a shorter persistence time than the red and green phosphors, and likewise the red phosphor has a shorter persistence time than the green phosphor. Therefore, the invention provides for the information delivered to the blue phosphor and to the red phosphor to be delayed with respect to that delivered to the green phosphor in order to correct the afterglow effect. To do this, the movement between two successive images is estimated and the subscans associated with the blue and red phosphors are displaced in the opposite direction to the movement, the amplitude of the displacement depending on the type of phosphor.

It will be recalled that a video image is displayed on a plasma display panel (PDP) by subscans distributed over the image display period and that a set of subscans is provided for each type of phosphor.

In the rest of the description and to simplify the figures illustrating the method of the invention, it will be assumed that the red and green phosphors have identical persistence times. Thus only the information delivered to the blue phosphor is delayed with respect to that delivered to the red and green phosphors.

FIG. 2A shows the subscans for a moving object in two successive images I and I+1. In this figure, the x-axis represents the pixels of images I and I+1 and the y-axis represents time. The moving image is displaced by 4 pixels between image I and image I+1. For clarity of representation reasons, all the subscans associated with the red phosphor and all those associated with the green phosphor are merged in FIG. 2A and are represented by bands of oblique lines. The subscans associated with the blue phosphor are represented by black bands as background of those associated with the red and green phosphors.

According to the invention, the movement of the object between images I and I+1 is estimated. A movement vector MV is then computed. The subscans associated with the blue colour are then displaced in the opposite direction to the movement. This displacement of the subscans associated with the blue phosphor is illustrated by FIG. 2B. The amplitude of the displacement depends on the value of the movement vector MV and on the type of phosphor in question.

In the case illustrated in FIG. 2B, the amplitude of the movement is equal to ΔMV=k×MV, with k=¼, i.e. 1 pixel. The coefficient k applied to the vector MV depends on the time response characteristics of the phosphors and on the average distribution of the illumination times. The coefficient k=¼ corresponds to an approximation of the average advance of the blue light centre of gravity with respect to the red and green centres of gravity for the various possible illuminations. The coefficient k may be modified according to the phosphors chosen, but also according to the number of subscans and the distribution of the illumination weights between the subscans.

Advantageously, the subscans are also displaced according to their temporal position in the image time slot in order to also correct the effects of contouring inherent in plasma display panels, as disclosed, for example, in European Patent Application No. 0 980 059. This method of implementation is illustrated by FIG. 2C. The subscans, whatever the type of phosphor to which they relate, are then displaced in the direction of movement in order to compensate for contouring defects. Afterglow compensation is therefore cumulative with contouring compensation, but only for the blue phosphors.

Very many structures for implementing the method of the invention are possible. One illustrative example is shown in FIG. 3. An image memory 10 receives a stream of images to be stored. The size of the memory allows at least three images to be stored, image I+1 being stored while image I is being processed using image I−1. A computing circuit 11, for example a signal processor, computes the movement vectors to be associated with the various images, shifts the image subscans according to the method described above and delivers the ignition signals to the row 12 and column 13 drivers of a plasma tile 14. A synchronization circuit 15 is provided for synchronizing the drivers 12 and 13. This structure is given merely as an illustration.

Other versions of the invention are quite possible. The embodiments described above show systems using three types of phosphor in order to have true colour rendition. Specific systems may use a smaller number of phosphors if the application does not require image reproduction in true colour. The invention applies when there are two types of phosphor having different time responses.

According to the methods of implementation described, only the blue is corrected. It goes without saying that, in order to have perfect correction, the red would also have to be compensated for. However, such a compensation is of little interest as the differences between green and red are imperceptible. On the other hand, if more powerful phosphors exhibit greater dispersions between each pair of colours, it would then be necessary to compensate for the two colours according to the method of the invention.

1) Method of displaying a sequence of video images on a plasma display panel comprising a plurality of elementary cells each including one type of phosphor from among at least two types of homogeneously distributed phosphors (blue, green, red), the display of a video image taking place for a display period divided by a plurality of subscans during which each elementary cell emits or does not emit coloured light according to the type of phosphor with which it is associated, characterized in that a movement vector corresponding to movement between two successive images is computed and then the subscans associated with at least one type of phosphor are displaced, the amplitude of the displacement depending on the amplitude of the movement vector and on the type of phosphor.

2) Process according to claim 1, wherein each image subscan is furthermore displaced according to its temporal position within the display period and to the amplitude of the movement vector.

3) Process according to claim 1, wherein three types of phosphor (blue, green, red) are used.

4) Plasma display panel comprising a plurality of elementary cells each including one type of phosphor from among at least two types of homogeneously distributed phosphors (blue, green, red), the display of a video image taking place during a display period divided by a plurality of subscans during which each elementary cell emits or does not emit coloured light according to the type of phosphor with which it is associated, characterized in that it includes a movement estimator for computing a movement vector corresponding to movement between two successive images and means for displacing the subscans associated with at least one type of phosphor, the amplitude of the displacement depending on the amplitude of the movement vector and on the type of phosphor.

5) Plasma display panel according to claim 4, wherein it furthermore includes means for displacing each image subscan according to its temporal position within the display period and to the amplitude of the movement vector.

6) Plasma display panel according to claim 4, wherein it comprises three types of phosphor (blue, green, red).
